(19) United States
(12) Patent Application Publication
(10) Pub. No.: US 2016/0263712 A1
(43) Pub. Date: Sep. 15, 2016

(54) ADDITIVE REPAIR FOR COMBUTSTER LINER PANELS

(71) Applicant: UNITED TECHNOLOGIES CORPORATION, Farmington, CT (US)

(72) Inventors: Steven Ivory, Ashford, CT (US); John H. Finn, Northford, CT (US); Monika D. Kinstler, Manchester, CT (US)

(21) Appl. No.: 15/032,576

(22) PCT Filed: Jan. 20, 2015
(86) PCT No.: PCT/US2015/011973

§ 371 Date: Apr. 27, 2016

Related U.S. Application Data
(60) Provisional application No. 61/931,140, filed on Jan. 24, 2014.

(51) Int. Cl. B23P 6/00; F23R 3/00

(52) U.S. Cl. CPC B23P 6/007; F23R 3/002; B23P 2700/13; B33Y 10/00

(57) ABSTRACT

A method of additively repairing a combustor liner panel includes removing a combustor liner panel from a combustor, inspecting the combustor liner panel to identify a damaged portion, removing material from the combustor liner panel around the damaged portion to form a repair zone having a substantially flat platform, and adding repair material to the repair zone on a layer by layer basis using an additive repair process.

### BACKGROUND

In a gas turbine engine, combustion of a mixture of fuel and air takes place within a combustor. A combustor typically contains several components including a case, a liner and fuel injector. Combustor liners serve to contain the combustion process and introduce the various airflows into the combustion zone where combustion occurs. Combustor liners are typically annular structures within a combustor, with the inner surface(s) of the liner in proximity to the combustion zone. Because the combustor liner contains the combustion process, it must be designed and built to withstand high temperature cycles. As a result, combustor liners often contain superalloys and/or thermal barrier coatings.

Some combustor liners are designed so that the liner is constructed of a plurality of combustor liner tiles. Each combustor liner tile is separately connected to the combustor case, another combustor liner tile or another structure within the combustor to form a network of tiles that yields the annular combustor liner. Such a design allows a more cost effective approach to repair and replacement. Combustor liner tiles become damaged over time due to thermal cycling and oxidation. When a tile becomes damaged, the damaged tile can be removed from the combustor and repaired or replaced. This makes repairs easier, as the surface of a removed tile is more accessible than the surface of an untiled combustor liner. Replacement is also more cost effective, as a damaged tile can be replaced rather than the entire combustor liner.

Welding can sometimes be used to repair cracks and other small defects on combustor liners and liner panels. However, welding repairs can be difficult due to the relatively poor weldability of the base metals typically used in combustor liner panels. Additionally, for more significant damage, welding repairs have the potential to create problems. Relatively high temperatures are required for welding repairs. These high temperatures can cause the liner panels to become distorted, leaving the repaired panel unsuitable for redeployment and reuse. Additionally, for significant erosion of the base metal, welding repairs are simply not suitable. Welding is also a manual process requiring the constant attention of a repair operator. Furthermore, conventional weld filler alloy compositions generally have inferior mechanical properties, oxidation resistance and corrosion resistance compared to the base alloy composition.

### SUMMARY

A method of additively repairing a combustor liner panel includes removing a combustor liner panel from a combustor, inspecting the combustor liner panel to identify a damaged portion, removing material from the combustor liner panel around the damaged portion to form a repair zone having a substantially flat platform, and adding repair material to the repair zone on a layer by layer basis using an additive repair process.

### BRIEF DESCRIPTION OF THE DRAWINGS

FIG. 1 is a schematic illustration of one embodiment of a method for additively repairing a combustor liner panel.

FIG. 2 is a front view of a combustor liner panel.

FIG. 2A is a cross section view of the combustor liner panel of FIG. 2.

FIG. 3 is a view of a damaged combustor liner panel.

FIG. 3A is a front view of the damaged combustor liner panel of FIG. 3.

FIG. 3B is a view of another damaged combustor liner panel.

FIG. 4 is a view of the damaged combustor liner panel of FIG. 3 following material removal.

FIG. 4A is a front view of the combustor liner panel of FIG. 4.

FIG. 5 is a view of the damaged combustor liner panel of FIG. 4 during repair.

FIG. 6 is a view of an additively repaired combustor liner panel.

FIG. 7A is a view of the damaged combustor liner panel of FIG. 3 following material removal.

FIG. 7B is a view of the damaged combustor liner panel of FIG. 7A during repair.

FIG. 7C is a view of an additively repaired combustor liner panel.

FIG. 8 is a schematic illustration of another embodiment of a method for additively repairing a combustor liner panel.

### DETAILED DESCRIPTION

The present invention provides method of additively repairing a combustor liner panel. The method described herein enables the repair of significantly damaged combustor liner panels in a cost effective manner. The disclosed repair method provides for the salvage of significantly damaged liner panels and their repair without the distortion caused by typical welding repair methods. Additive repair facilitates the use of a base alloy composition or an alternative filler that provides mechanical, oxidation and corrosion performance equal to or better than the base alloy composition.

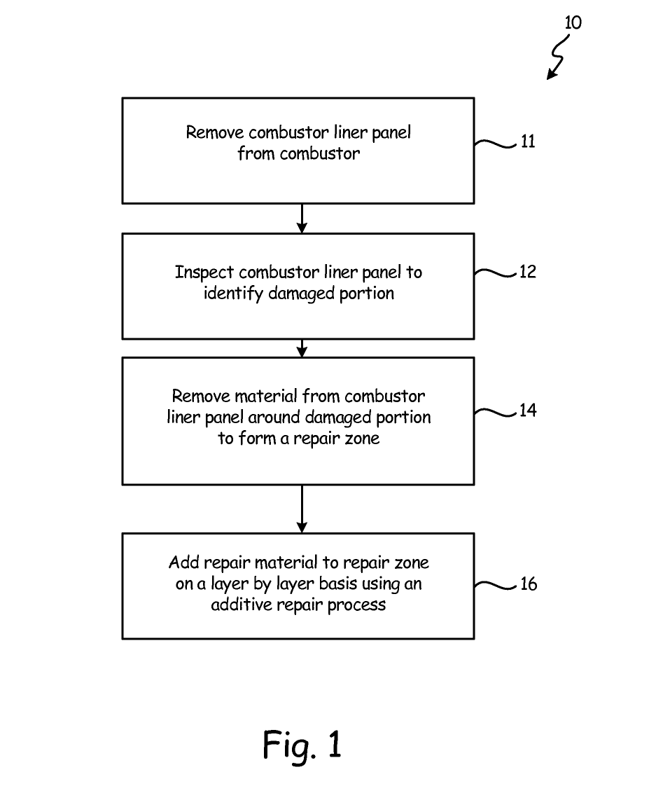

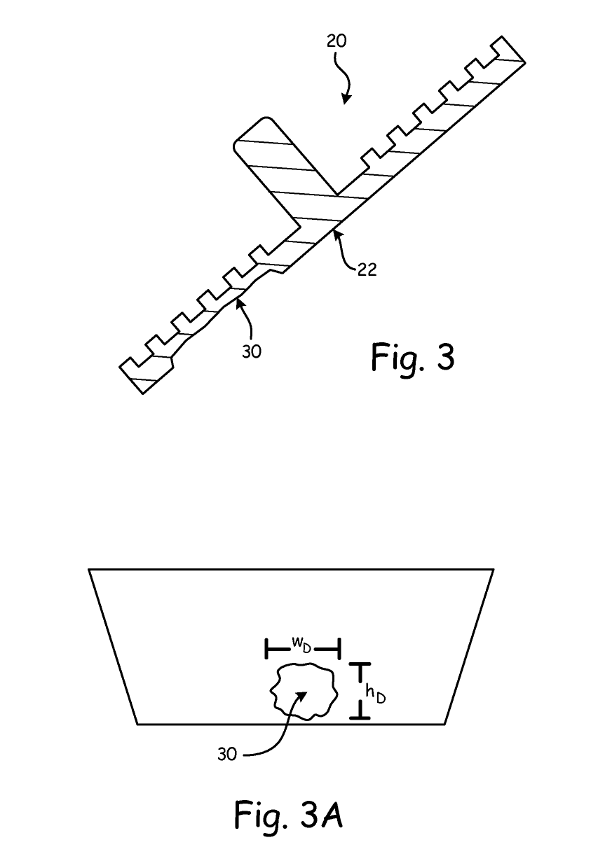

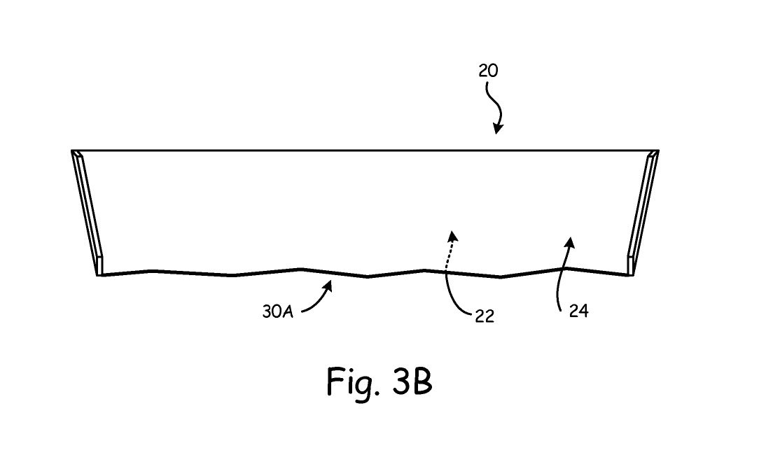

FIG. 1 schematically illustrates a method for additively repairing a combustor liner panel. Method 10 includes removing a combustor liner panel from a combustor (step 11), inspecting the combustor liner panel to identify a damaged portion (step 12), removing material from the combustor liner panel around the damaged portion to form a repair zone having a substantially flat platform (step 14), and adding repair material to the repair zone on a layer by layer basis using an additive repair process (step 16). Method 10 provides a repaired combustor liner panel that can be reconnected to the combustor for further use. The following description and FIGS. 3, 3A, 3B, 4, 4A, 5 and 6 help illustrate the steps of method 10.

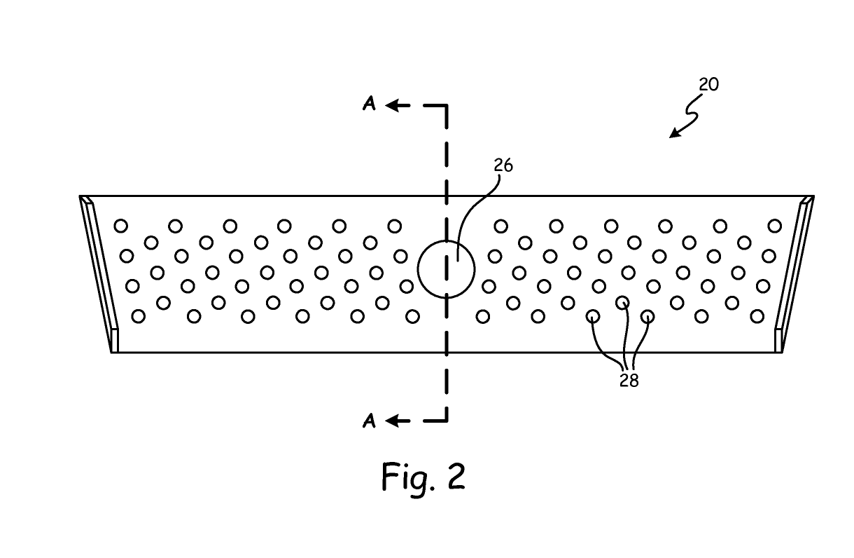

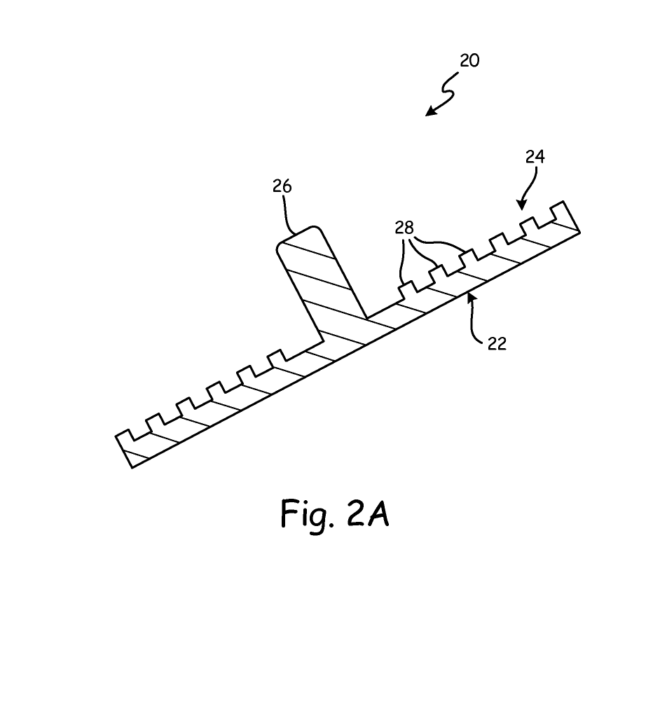

FIGS. 2 and 2A illustrate undamaged combustor liner panel 20. FIG. 2 shows a front view of liner panel 20 and FIG. 2A shows a cross section view of panel 20 in FIG. 2 taken along the line A-A. Multiple combustor liner panels 20 are arranged side-by-side to form an annular combustor liner. Combustor liner panels 20 are generally curved radially in order to form the annular liner. In some embodiments, sixty or more liner panels 20 are used to form the combustor liner. Combustor liner panels 20 are also sometimes curved axially (perpendicular to the radial axis) in order to narrow the combustion zone downstream of the fuel injector(s). Thus, some combustor liner panels 20 are curved both radially and axially.

Due to the high temperatures to which combustor liner panels 20 are exposed, liner panels 20 are typically constructed of high strength nickel alloys. In one embodiment, liner panels 20 contain B1900+Hf alloy (Aerospace Material Specification (AMS) 5406). B1900+Hf is a nickel alloy having a nominal chemical composition of about 8% Cr, 10% Co, 6% Mo, 6% Al, 1% Ti, 4% Ta, 0.10% Zr, 0.1% C, 0.015% B and 1.5% Hf with the balance as Ni.

As shown in FIG. 2A, combustor liner panel 20 includes front surface 22, back side 24, connection device 26 and pins 28. Front surface 22 is exposed to the combustion zone of the combustor and is exposed to the high temperatures resulting from combustion. Back side 24 is located generally opposite front surface 22 and does not experience temperatures as high as those of front surface 22. Connection device 26 is used to connect liner panel 20 to the wall of the combustor or another structure in order to hold liner panel 20 in place. In one embodiment, connection device 26 is a threaded stud that projects from back side 24. Pins 28 located on back side 24 of liner panel 20 are designed to radiate heat from liner panel 20. In some embodiments, liner panels 20 and all their features (front surface 22, back side 24, connection device 26 and pins 28) are manufactured entirely by casting.

In some embodiments, front surface 22 includes a thermal barrier coating (TBC). Thermal barrier coatings can be applied to front surface 22 following casting by spraying the TBC onto front surface 22. In some embodiments, back side 24 (including pins 28) can include an aluminide coating to provide additional heat and oxidation resistance.

FIGS. 3 and 3A illustrate a significantly damaged combustor liner panel 20. As shown in FIG. 3, portion 30 of front surface 22 of liner panel 20 has become damaged and some material is missing from front surface 22. FIG. 3 illustrates a front view of damaged combustor liner panel 20. Where damaged portion 30 is sufficiently large, welding repairs are not suitable as noted above. Depending on the base material of combustor liner panel 20, sufficiently large regions of damage include those that have a surface area (height×width) greater than about 0.25 square inches (161 square millimeters) or those that have a surface area greater than about one square inch (645 square millimeters). FIG. 3B illustrates another significantly damaged combustor liner panel 20. Here, material along the bottom portion of front surface 22 has been burned or oxidized away (damaged portion 30A). Due to the length of the damage along the bottom of liner panel 20, welding repairs are not suitable.

In step 11 of method 10, damaged combustor liner panel 20, such as those shown in FIGS. 3 and 3B, are removed from the combustor. Once removed from the combustor, combustor liner panel 20 is inspected in step 12 to determine the extent of damage and identify the damaged portion(s) of liner panel 20.

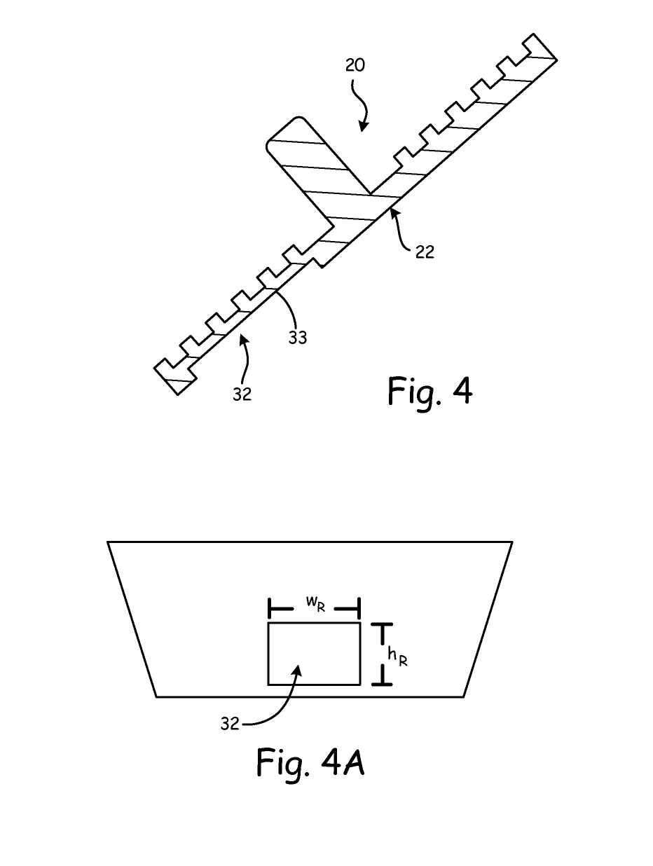

In step 14, material is removed from combustor liner panel 20 around the damaged portion to form a repair zone having a substantially flat platform. As shown in FIGS. 4 and 4A, material is removed from the region around damaged portion 30 to form repair zone 32. Material is removed from and around damaged portion 30 to create repair zone 32 having substantially flat platform 33 from which the additive repair process of step 16 (described in greater detail below) can proceed. Platform 33 has a generally smooth surface so that layers of repair material can be easily built up from platform 33. A rough starting surface cannot be easily repaired using an additive process; the modeling required to factor in the rough starting surface tends to make the process more difficult and inefficient.

To generate repair zone 32 and platform 33, material is removed from front surface 22 as shown in FIGS. 4 and 4A. The size of repair zone 32 is based on the size of damaged portion 30 (shown in FIGS. 3 and 3A) and has a height (h_{R}) equal to or greater than the height of damaged portion 30 (h_{D}), has a width equal (w_{R}) to or greater than the width of damaged portion 30 (w_{D}), and has a depth (d_{R}) equal to or greater than the depth of damaged portion 30 (d_{D}). That is h_{R}>h_{D}, w_{R}>w_{D}, and d_{R}>d_{D} as illustrated in FIGS. 3, 3A, 4 and 4A. By forming repair zone 32 to have a height, width and depth greater than those of damaged portion 30, repair zone 32 possesses generally smooth surfaces suitable for additive repair. FIGS. 4 and 4A illustrate cuboid repair zone 32. Other geometries of repair zone 32, such as prism or cylinder, are also possible. Following material removal step 14, repair zone 32 has a height, width and depth that will facilitate additive repair using a desired repair material to provide a repaired combustor liner panel having the desired characteristics concerning thermal and oxidative stability.

In one embodiment, material is removed from damaged portion 30 using electrical discharge machining (EDM). In another embodiment, material is removed by abrading damaged portion 30 until it yields repair zone 32. As noted above, repair zone 32 generally has a height and width greater than about 0.25 square inches (161 square millimeters) or greater than about one square inch (645 square millimeters).

In step 16, repair zone 32 of combustor liner panel 20 is filled with a repair material on a layer by layer basis starting at platform 33 using an additive repair process. Layer by layer, the repair material is deposited and sintered or melted until the repair material occupies repair zone 32 such that combustor liner panel 20 has obtained dimensions identical or equivalent to its original form. Step 16 is carried out in a rapid prototyping machine using an additive repair process. Additive repair is a low heat input process, considerably lower than the welding repair process described above. Compared to welding repairs, the additive repair process allows the incorporation of more metal at lower temperatures with less distortion. Additive repair is also suitable for complex geometries, such as liner panels 20 that are curved in both the radial and axial directions, which may prove difficult for manual welding techniques. A computer-aided design (CAD) model or other three-dimensional model of repair zone 32 provides instructions for the additive repair process.

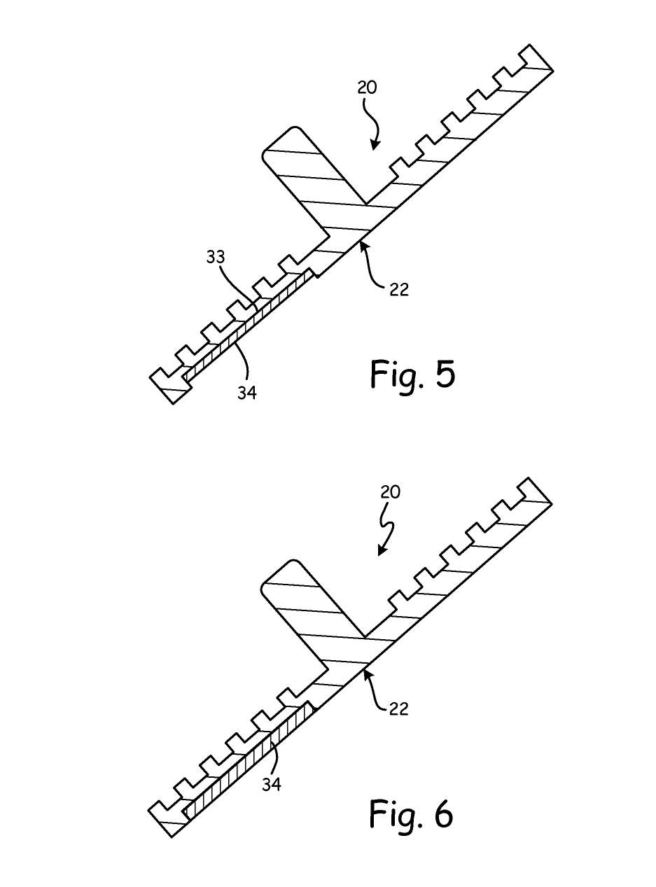

In one embodiment, the additive repair process includes direct metal laser sintering. In another embodiment, the additive repair process includes electron beam melting. During the additive repair process, a layer of repair material is deposited within repair zone 32. Following deposition, the material is sintered or melted so that the repair material joins the previous layer of material. FIG. 5 illustrates liner panel 20 in one stage of step 16, in which repair material 34 has filled a portion of repair zone 32. Once repair material 34 has solidified to the necessary extent, an additional layer of repair material 34 is deposited within repair zone 32 and then sintered or melted. This process continues until repair zone 32 has been filled with repair material 34. FIG. 6 illustrates liner panel 20 once step 16 has been completed.

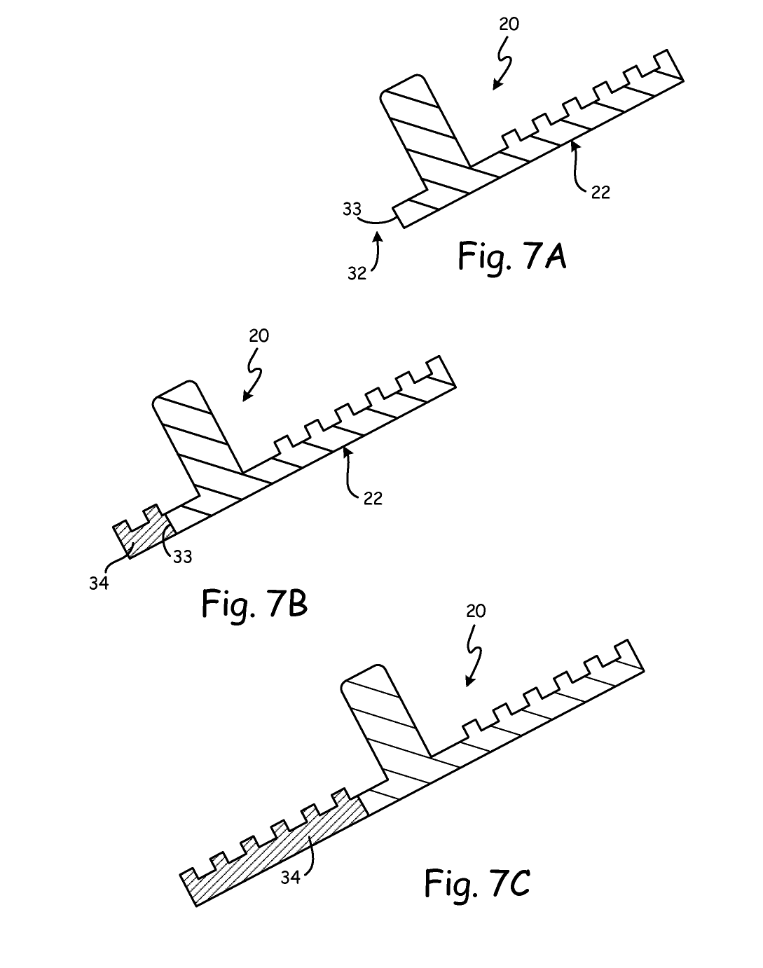

FIGS. 7A, 7B and 7C show another embodiment of the additive repair process for the damage combustor liner panel 20 shown in FIG. 3. As shown in FIG. 7A, instead of removing material along front surface 22 to form repair zone 32, repair zone 32 and platform 33 are formed by removing all of damaged portion 30 from liner panel 20. Damaged portion 30 from front surface 22 to back side 24 is cut away or otherwise removed from liner panel 20 to form platform 33 from which the additive repair process proceeds. FIG. 7B illustrates liner panel 20 during step 16, where layers of repair material 34 have been added to replace the removed section of liner panel 20 from front surface 22 to back side 24, including pins 28. FIG. 7C illustrates liner panel 20 once step 16 has been completed. In some embodiments, repair material 34 is the same as the base material used to construct combustor liner panels 20. In one embodiment, liner panels 20 include B1900+Hf alloy as the base material and repair material 34 is B1900+Hf alloy. In other embodiments, a repair material 34 having better weldability and comparable oxidative stability than the base material is selected. In one embodiment, repair material 34 is Haynes 230 alloy. Haynes 230 alloy is a nickel alloy having a nominal chemical composition of about 22% Cr, 14% W, 2% Mo, 3% (maximum) Fe, 5% (maximum) Co, 0.5% Mn, 0.4% Si, 0.3% Al, 0.10% C, 0.02% La and 0.015% (maximum) B with the balance as Ni. In another embodiment, repair material 34 is Rene 142 alloy. Rene 142 alloy is a nickel alloy having a nominal chemical composition of about 12% Co, 6.8% Cr, 6.35% Ta, 6.15% Al, 4.9% W, 2.8% Re, 1.5% Mo, 1.5% Hf, 0.12% C, 0.02% Zr and 0.015% B with the balance as Ni. In another embodiment, repair material 34 is PWA 795 alloy. PWA 795 alloy is a cobalt alloy having a nominal chemical composition of about 20% Cr, 15% Ni, 9% W, 4.4% Al, 3% Ta, 1% Hf, 0.45% Y, 0.35% C and 0.2% Ti with the balance as Co. According to the repair method described herein, repair material 34 can be any nickel- or cobalt-based alloy filler that offers an advantage in weldability, improved oxidation resistance, or elevated temperature mechanical property performance.

Once repair material 34 has sufficiently filled repair zone 32 and solidified, repaired combustor liner panel 20 is removed from the rapid prototyping machine and can be reinstalled in the combustor for reuse.

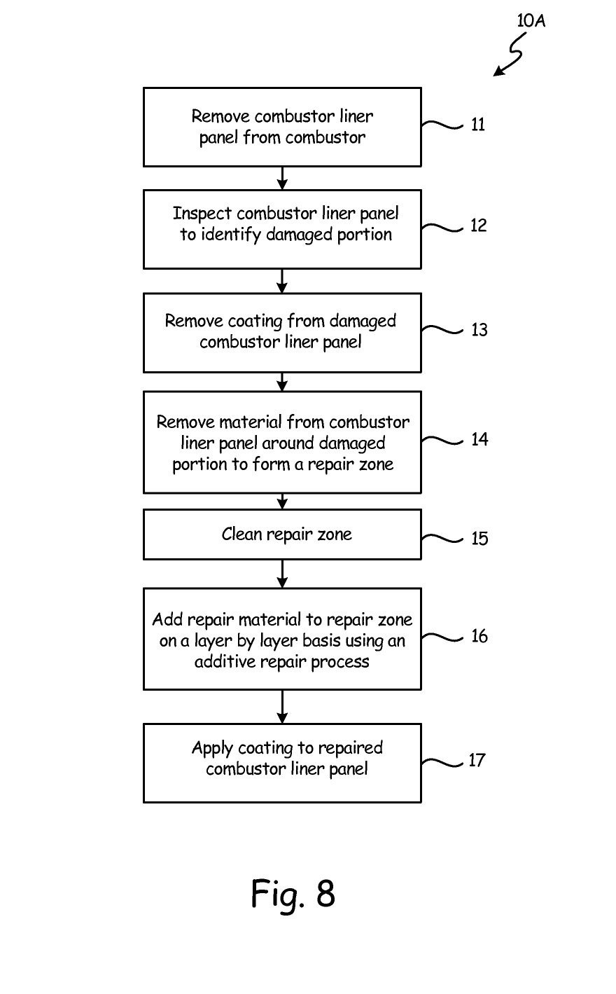

FIG. 8 schematically illustrates another method for additively repairing a combustor liner panel. Method 10A includes the steps shown in method 10 of FIG. 1, but also includes additional steps. As previously noted, some combustor liner panels 20 include a TBC. Prior to additive manufacturing, this TBC must be removed. In step 13, the TBC is removed from front surface 22 of liner panel 20. In some embodiments, step 13 is completed prior to the formation of repair zone 32 in step 14. In other embodiments, steps 13 and 14 are performed concurrently.

Method 10A also includes cleaning step 15. Once repair zone 32 has been formed, the exposed surfaces of liner panel 20 within repair zone 32 including platform 33 are cleaned to better prepare the surfaces for the additive repair process. Suitable cleaning steps include abrading the surfaces of repair zone 32 with a wire brush to remove any loose particulate matter and/or wiping or spraying repair zone 32 with a solvent to remove dust, dirt or debris.

Method 10A also includes coating restoration step 17. The TBC removed from liner panel 20 is replaced following the additive repair process of step 16 and after repair material 34 has solidified. Replacement TBC is applied in step 17 by spraying or other deposition methods. For those liner panels 20 containing an aluminide coating on back side 24, the aluminide coating may be touched up during coating restoration step 17. A coating, such as PWA 596 or PWA 545, is applied to back side 24.

The present invention provides a cost effective and efficient process for repairing combustor liner panels. By using an additive repair process, significantly damaged combustor liner panels that are not suitable for welding repair can be salvaged and repaired for reuse rather than requiring more costly replacement.

### Discussion of Possible Embodiments

The following are non-exclusive descriptions of possible embodiments of the present invention.

A method can include removing a combustor liner panel from a combustor, inspecting the combustor liner panel to identify a damaged portion, removing material from the combustor liner panel around the damaged portion to form a repair zone having a substantially flat platform, and adding repair material to the repair zone on a layer by layer basis using an additive repair process.

The method of the preceding paragraph can optionally include, additionally and/or alternatively, any one or more of the following features, configurations and/or additional components:

A further embodiment of the foregoing method can include that the additive repair process comprises direct metal laser sintering or electron beam melting.

A further embodiment of any of the foregoing methods can further include removing a coating from the combustor liner panel prior to removing material from the combustor liner panel and applying a coating to the combustor liner panel following the additive repair process.

A further embodiment of any of the foregoing methods can further include cleaning the repair zone with a wire brush, solvent or combinations thereof prior to the additive repair process.

A further embodiment of any of the foregoing methods can include that the step of removing material from the combustor liner panel around the damaged portion is performed using electrical discharge machining.

A further embodiment of any of the foregoing methods can include that the combustor liner panel comprises B1900+Hf alloy.

A further embodiment of any of the foregoing methods can include that the repair material comprises B1900+Hf alloy.

A further embodiment of any of the foregoing methods can include that the repair material is a nickel- or cobalt-based alloy.

A further embodiment of any of the foregoing methods can include that the repair material is a material selected from the group consisting of Haynes 230 alloy, Rene 142 alloy, PWA 795 alloy and combinations thereof.

A further embodiment of any of the foregoing methods can include that the combustor liner panel has a surface that is curved both radially and axially.

A further embodiment of any of the foregoing methods can include that the damaged portion has a surface area greater than 0.25 square inches (161 square millimeters).

A further embodiment of any of the foregoing methods can include that the damaged portion has a surface area greater than one square inch (645 square millimeters).

Although the present invention has been described with reference to preferred embodiments, workers skilled in the art will recognize that changes may be made in form and detail without departing from the spirit and scope of the invention.

1. A method of additively repairing a combustor liner panel, the method comprising:
removing a combustor liner panel from a combustor;
inspecting the combustor liner panel to identify a damaged portion;
removing material from the combustor liner panel around the damaged portion to form a repair zone having a substantially flat platform; and
adding repair material to the repair zone on a layer by layer basis using an additive repair process.

2. The method of claim 1, wherein the additive repair process comprises direct metal laser sintering or electron beam melting.

3. The method of claim 1, further comprising:
removing a coating from the combustor liner panel prior to removing material from the combustor liner panel; and
applying a coating to the combustor liner panel following the additive repair process.

4. The method of claim 1, further comprising:
cleaning the repair zone with a wire brush, solvent or combinations thereof prior to the additive repair process.

5. The method of claim 1, wherein the step of removing material from the combustor liner panel around the damaged portion is performed using electrical discharge machining.

6. The method of claim 1, wherein the combustor liner panel comprises B1900+Hf alloy.

7. The method of claim 6, wherein the repair material comprises B 1900+Hf alloy.

8. The method of claim 1, wherein the repair material is a nickel- or cobalt-based alloy.

9. The method of claim 1, wherein the repair material is a material selected from the group consisting of Haynes 230 alloy, Rene 142 alloy, PWA 795 alloy and combinations thereof.

10. The method of claim 1, wherein the combustor liner panel has a surface that is curved both radially and axially.

11. The method of claim 1, wherein the damaged portion has a surface area greater than 0.25 square inches (161 square millimeters).

12. The method of claim 1, wherein the damaged portion has a surface area greater than one square inch (645 square millimeters).
